(19) United States
(12) Patent Application Publication
(10) Pub. No.: US 2021/0023722 A1
(43) Pub. Date: Jan. 28, 2021

(54) ARTICULATED ARM ROBOT JOINT ARRANGEMENT

(71) Applicant: KUKA Deutschland GmbH, Augsburg (DE)

(72) Inventors: Andre Reekers, Augsburg (DE); Moritz Zasche, Augsburg (DE); Florian Zurmuehlen, Friedberg (DE); Wolfgang Schober, Poettmes (DE); Martin Riedel, Augsburg (DE); Jorge Torres, Neusaess (DE)

(21) Appl. No.: 16/982,927

(22) PCT Filed: Mar. 11, 2019
(86) PCT No.: PCT/EP2019/055964

§ 371 Date: Sep. 21, 2020

(30) Foreign Application Priority Data
Mar. 21, 2018 (DE) 10 2018 204 308.6

(51) Int. Cl. B25J 17/00; B25J 9/10; B25J 19/00

(52) U.S. Cl. CPC B25J 17/00; B25J 19/0029; B25J 9/108

(57) ABSTRACT

A joint arrangement for an articulated arm robot includes a first structural member and a second structural member which is mounted, in particular floatingly mounted, in a pivot bearing on the first structural member. A first cable has a first cable portion arranged on the first structural member and a second cable portion arranged on the second structural member. The first and second cable portions are connected in a first cable loop. In one embodiment the joint arrangement has a torque sensor.

### CROSS-REFERENCE TO RELATED APPLICATIONS

This application is a national phase application under 35 U.S.C. § 371 of International Patent Application No. PCT/EP2019/055964, filed Mar. 11, 2019 (pending), which claims the benefit of priority to German Patent Application No. DE 10 2018 204 308.6, filed Mar. 21, 2018, the disclosures of which are incorporated by reference herein in their entirety.

### TECHNICAL FIELD

The present invention relates to a joint arrangement for an articulated arm robot, an articulated arm robot having the joint arrangement, and to a method for assembly, and to a use of the joint arrangement.

The object of the present invention is that of improving an articulated arm robot.

### SUMMARY

This object is achieved by a joint arrangement having the features disclosed herein, an articulated arm robot comprising at least one joint arrangement described herein, a method for the assembly thereof, and the use thereof.

According to one embodiment of the present invention, a joint arrangement for an articulated arm robot, in particular one or more joint arrangements of an articulated arm robot (in each case) comprises a first structural member and a second structural member of the robot, which member is mounted, in one embodiment in a cantilever manner, in a pivot bearing on the first structural member.

As a result, in one embodiment larger adjustment (angle) ranges can be achieved and/or possible pinch points between structural members of an articulated arm robot can be reduced.

According to one embodiment of the present invention, the or one or more of the joint arrangement(s in each case) comprises a first cable having a first cable portion that is arranged, in particular fixed, on, in particular in, the first structural member (in each case), and a second cable portion that is arranged, in particular fixed, on, in particular in, the second structural member (in each case), the first and second cable portion being interconnected in a first, in particular open, cable loop.

In one embodiment, the or one or more of the joint arrangement(s in each case) comprises one or more further cables, each having a first cable portion that is arranged, in particular fixed, on, in particular in, the first structural member (in each case), and a second cable portion that is arranged, in particular fixed, on, in particular in, the second structural member (in each case), the first and second cable portion likewise being interconnected in a (further), in particular open, cable loop.

In one embodiment, the (first and/or further) cable loop (in each case) adjoins or transitions into the (respective) first and/or second cable portion.

In one embodiment, the (first and/or further) cable loop extends or rolls on or against one another, in the case of twisting of the first and second structural member, and thus advantageously compensates the change in the spacing between the first and second cable portion or is provided for this purpose, in particular is designed or used for this purpose.

It has surprisingly been found that cable loops of this kind can be used particularly advantageously, in particular in the case of articulated arm robots having cantilever-mounted structural members.

In one embodiment, the cable loops of the (in one embodiment all) cable(s) in which in each case one first cable portion arranged, in particular fastened, on, in particular in, the first structural member, and one second cable portion arranged, in particular fastened, on, in particular in, the second structural member, are connected, arranged one inside the other, and/or curved in the same direction, and/or extend or roll in the same direction or on one side, and/or encompass the pivot bearing in the same direction or on one or the same side, or are arranged in such a way or used in such a way.

As a result, in one embodiment, a diameter of the joint arrangement can advantageously be reduced compared with an embodiment in which at least two cable loops oppose one another in a manner curved in opposing directions, extend away in opposite directions, or encompass the pivot bearing from two sides.

In one embodiment, a radial offset between the first cable portions, a radial offset between the second cable portions, and/or a radial offset between the cable loops is (in each case) smaller than an, in particular minimum, maximum and/or average, cable diameter, in particular in one or more cable loops. In the present case, a radial offset is understood in particular as a spacing in a radial direction, which is in particular perpendicular on an axis of rotation and rotational direction of the pivot bearing, between surface centers of the corresponding cables.

As a result, in one embodiment, a diameter of the joint arrangement can advantageously be (further) reduced compared with an embodiment in which at least two cable loops overlap one another in opposing directions.

In another embodiment the joint arrangement comprises a second cable, having a first cable portion that is arranged, in particular fixed, on, in particular in, the first structural member, and a second cable portion that is arranged, in particular fixed, on, in particular in, the second structural member, the first and second cable portion of the second cable being connected in a second cable loop, and, in one embodiment, the second cable loop being opposite the first cable loop of the first cable, always without any overlap, or the first and second cable loops being arranged or used in this way.

In a development, the joint arrangement can comprise one or more further cables, each having a first cable portion that is arranged, in particular fixed, on, in particular in, the first structural member, and a second cable portion that is arranged, in particular fixed, on, in particular in, the second structural member, the first and second cable portion each being connected in a cable loop, and said cable loop and the first cable loop being arranged one inside the other and/or being curved in the same direction and/or extending in the same direction and/or encompassing the pivot bearing in the same direction, and said cable loop(s) also being arranged such that it/they is/are opposite the second cable loop, always without any overlap.

In addition or alternatively, in one embodiment the joint arrangement can comprise one or more further cables, each having a first cable portion that is arranged, in particular fixed, on, in particular in, the first structural member, and a second cable portion that is arranged, in particular fixed, on, in particular in, the second structural member, the first and second cable portion each being connected in a cable loop, and said cable loop and the second cable loop being arranged one inside the other and/or being curved in the same direction and/or extending in the same direction and/or encompassing the pivot bearing in the same direction, and said cable loop(s) also being arranged such that it/they is/are opposite the first cable loop, always without any overlap.

As a result, in one embodiment, an axial installation height of the joint arrangement can be reduced.

In one embodiment, the joint arrangement comprises a torque sensor for recording an axial torque between the first and second structural member, and/or an electric drive for adjusting the first and second structural member with respect to one another.

In particular on account of an advantageously reduced influence of the cable rigidity or cable restoring force, the present invention can be used particularly advantageously in joint arrangements comprising torque sensors.

In one embodiment the torque sensor and/or the electric drive is/are covered in particular axially by the first cable loop, at least in part (in each case).

As a result, in one embodiment, an axial installation height of the joint arrangement can be reduced.

In one embodiment, the first cable, and in a development also the second and/or one or more of the mentioned further cables, can (in each case) comprise one or more electrical, hydraulic and/or pneumatic line(s), in particular for supplying a robot drive. Said cables can, in turn, be designed as (individual) cables and/or be combined with the first, second or further cable, in particular packed, twisted and/or connected for example by individual fastening means such as cable ties or the like, and in one embodiment can be shrouded together, at least in part. In one embodiment, the first cable, and in a development also the second and/or one or more of the mentioned further cables, can (in each case) be an individual cable or a cable bundle consisting of a plurality of loose or connected (individual) cables.

As a result, in on embodiment distal actuators and/or sensors, or ones remote from the (robot) base can advantageously be supplied with energy, signals and/or drive means.

In one embodiment the axis of rotation of the pivot bearing of the joint arrangement is an articulation axis of the robot.

It has surprisingly been found that straight distal articulation axes or those remote from the (robot) base can be represented advantageously with joint arrangements according to the invention. Accordingly, in one embodiment the axis of rotation of the pivot bearing of the joint arrangement is used as an articulation axis of the robot.

In one embodiment, the articulated arm robot comprises at least two of the joint arrangements described herein, the axes of rotation (of the pivot bearings) of said joint arrangements in one embodiment being in parallel or being perpendicular to one another and/or following one another.

It has surprisingly been found that parallel and mutually perpendicular, in particular successive, axes of rotation, in particular a second, third and/or fifth axis of rotation (counted proceeding from the robot base), can be represented particularly advantageously using joint arrangements of this kind. Accordingly, in one embodiment a second, third and/or fifth axis of rotation (counted proceeding from the robot base) is an axis of rotation (of the pivot bearing) of a joint arrangement described here.

According to an embodiment of the present invention, in order to assemble a joint arrangement described herein the first cable loop is laid, and in a development the further cable loops described herein are also laid.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically illustrates an articulated arm robot according to an embodiment of the present invention;

FIG. 2 depicts a joint arrangement of the articulated arm robot according to an embodiment of the present invention; and

FIG. 3 depicts a joint arrangement of the articulated arm robot according to a further embodiment of the present invention.

### DETAILED DESCRIPTION

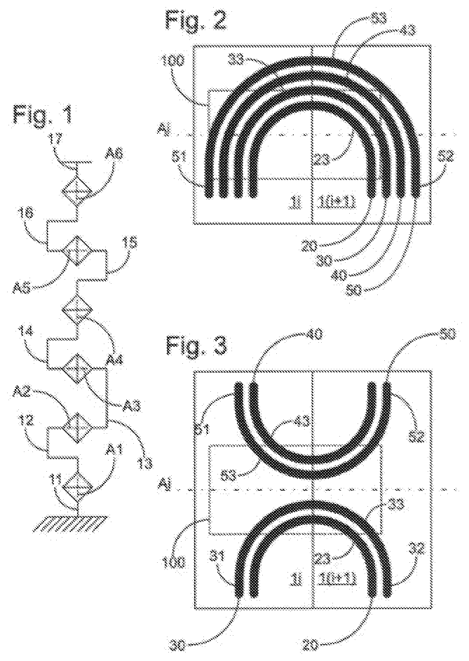

FIG. 1 shows, by way of example, a six-axis articulated arm robot according to an embodiment of the present invention. The axes of the robot or of the pivot bearing are denoted A1, . . . , A6, and the structural members are denoted 11, . . . , 17.

FIG. 2 is a plan view, perpendicular to the axis of rotation thereof, of a joint arrangement of the articulated arm robot according to an embodiment of the present invention. In this case, the axis of rotation Ai of FIG. 2 can in particular be the articulation axis A5.

The joint arrangement comprises a pivot bearing 100 which is shown only schematically and in which a first structural member 1i and a second structural member 1 (i+1) of the robot, i.e. for example the structural members 15, 16, are mounted in a cantilever manner against one another.

In addition or alternatively, a torque sensor for recording an axial torque between the first and second structural member, and/or an electric drive for adjusting the first and second structural member with respect to one another, can also be indicated or denoted by 100.

The joint arrangement comprises a total of four cables 20, 30, 40, 50, each comprising a first cable portion (of which, for the sake of clarity, only the first cable portion 51 of the cable 50 is denoted in FIG. 2) arranged on the first structural member 1i, and a second cable portion (of which, for the sake of clarity, in turn only the second cable portion 52 of the cable 50 is denoted in FIG. 2) arranged on the second structural member 1 (i+1), the first and second cable portion in each case being connected in a cable loop 23, 33, 43 or 53.

In the embodiment of FIG. 2, the cable loops 23, 33, 43, and 53 of the cables 20, 30, 40, 50 are arranged one inside the other and are curved in the same direction, extend or roll up in the same direction or on one side, and encompass the pivot bearing in the same direction or on the same side.

FIG. 3 shows, in a view corresponding to FIG. 2, a joint arrangement of the articulated arm robot according to a further embodiment of the present invention, again, for the sake of clarity, only the first cable portion 31 or 51 and the second cable portion 32 or 52 of the cable 30 or 50, respectively, being denoted. In this case, the axis of rotation Ai of FIG. 3 can in particular be the articulation axis A2 or A3. Mutually corresponding features are identified by the same reference signs, such that reference is made to the above description, and only differences are discussed in the following.

In the joint arrangement of FIG. 3, the cable loops 23, 33, 43 and 53 are arranged such that the cable loop 23 and the cable loop 33 are always opposite the cable loops 43 and 53 without any overlap, and accordingly, vice versa, the cable loop 43 and the cable loop 53 are always opposite the cable loops 23 and 33 without any overlap.

Although embodiments given by way of example have been explained in the preceding description, it is noted that a plurality of modifications are possible. It should furthermore be noted that the embodiments given by way of example are merely examples which are not intended to restrict the scope of protection, the applications and the structure in any ways. Instead, the above description provides guidance for a person skilled in the art to implement at least one embodiment given by way of example, it being possible for various amendments to be made, in particular in view of the function and arrangement of the described components, without departing from the scope of protection as emerges from the claims and the combinations of features equivalent thereto.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

11-17, 1i, 1 (i+1) structural member
A1-A6, Ai axis of rotation
20, 30, 40, 50 cable
31, 51 first cable portion
32, 52 second cable portion
23, 33, 43, 53 cable loop
100 pivot bearing/torque sensor/electrical drive

What is claimed is:

1-10. (canceled)

11. A joint arrangement for an articulated arm robot, comprising:
a first structural member of the robot;
a second structural member mounted on the first structural member in a pivot bearing;
at least one first cable having a first cable portion arranged on the first structural member and a second cable portion arranged on the second structural member;
wherein the first and second cable portions are connected in a first cable loop; and
at least one of:
a torque sensor configured for recording an axial torque between the first and second structural member, or
an electric drive configured for adjusting the first and second structural member with respect to one another.

12. The joint arrangement of claim 11, wherein the second structural member is mounted on the first structural member in a cantilever manner.

13. The joint arrangement of claim 12, wherein at least one of the torque sensor or electronic drive is at least partly covered by the first cable loop.

14. The joint arrangement of claim 11, wherein:
the at least one first cable comprises a plurality of first cables, each having respective first and second cable portions connected in a cable loop; and
at least one of:
the cable loops are arranged one inside the other,
the cable loops are curved in the same direction,
the cable loops extend in the same direction, or
the cable loops encompass the pivot bearing in the same direction.

15. The joint arrangement of claim 14, wherein a radial offset between at least one of the first cable portions, between the second cable portions, or between the cable loops is smaller than a diameter of the first cable.

16. The joint arrangement according to claim 11, further comprising:
at least one second cable, the second cable comprising a first cable portion arranged on the first structural member and a second cable portion arranged on the second structural member;
wherein the first and second cable portions of the second cable are connected in a second cable loop; and
wherein the first and second cable loops are arranged such that the first and second cable loops curve in directions opposite one another.

17. The joint arrangement of claim 16, wherein the oppositely curved first and second cable loops do not overlap.

18. The joint arrangement of claim 11, wherein the first cable comprises at least one electrical, hydraulic, or pneumatic line.

19. The joint arrangement of claim 18, wherein the at least one electrical, hydraulic, or pneumatic line is configured for supplying a robot drive.

20. An articulated arm robot, comprising:
at least one joint arrangement according to claim 11;
wherein an axis of rotation of the pivot bearing of the joint arrangement is an articulation axis of the robot.

21. The articulated arm robot of claim 20, comprising at least two joint arrangements;
wherein the axes of rotation of the joint arrangements are in parallel or are perpendicular to one another.

22. A method for assembling a joint arrangement for an articulated arm robot, the method comprising:
mounting a second structural member on a first structural member of the robot in a pivot bearing;
arranging a first cable portion of at least one first cable on the first structural member;
arranging a second cable portion of the at least one first cable on the second structural member; and
connecting the first and second cable portions in a first cable loop.
